(19) United States
(12) Patent Application Publication
(10) Pub. No.: US 2024/0420287 A1
(43) Pub. Date: Dec. 19, 2024

(54) DUAL-STAGE LOCAL AND GLOBAL IMAGE ENHANCEMENT

(71) Applicant: Faurecia IRYStec Inc., Montreal (CA)

(72) Inventors: Pranjay SHYAM, Montreal (CA); Hyunjin YOO, North Lancaster (CA); Tara AKHAVAN, Kirkland (CA)

(21) Appl. No.: 18/336,766

(22) Filed: Jun. 16, 2023

(51) Int. Cl. G06T 5/50; G06N 3/0464

(52) U.S. Cl. CPC G06T 5/50; G06N 3/0464; G06T 2207/20084; G06T 2207/30252

(57) ABSTRACT

A system and method is provided for enhancing an input image using a dual-stage image enhancement network. The method includes: generating locally-enhanced image data based on an input image using a local enhancement network as a part of a first stage, wherein the local enhancement network includes a local image encoder that generates local enhancement data that indicates one or more image enhancement techniques to apply to a local region of the input image; and generating globally-enhanced image data based on the locally-enhanced image data using a global enhancement network as a part of a second stage, wherein the global enhancement network includes a plurality of global feature subnetworks, and wherein each of the global feature subnetworks is configured to draw attention to a different aspect of the locally-enhanced image data.

### TECHNICAL FIELD

This disclosure relates to methods and systems for processing images and, in particular, addressing degradations at both a local and global level.

### BACKGROUND

Camera or other sensor output images in automotive applications are often degraded as a result of different weather conditions, including fog, rain, snow, sunlight, night, etc. Such degradation causes undesirable visual artifacts within the image captured by the camera or sensor. Depending on the application, the degradations can have tangible, technical effects, such as a decrease in a driver's visibility.

This disclosure refers to “image enhancement”, and that is to be understood as image quality—or the degree to which tangible objects within the field of view are visually represented in an accurate manner as such objects exist (or are to be expected to/estimated as existing) when unobscured or otherwise degraded.

Thus, enhancing the visibility of camera output has value in automotive fields, at least for purposes of avoiding or reducing a number of accidents. Many studies had been conducted to remove those degradations, including rain removal, defogging, and low-light image enhancement. However, those algorithms were limited to specific single degradation. Various weather conditions may result in multiple and complex image degradations rather than a single degradation for specific weather.

### SUMMARY

According to one aspect of the disclosure, there is provided a method for enhancing an input image using a dual-stage image enhancement network. The method includes: generating locally-enhanced image data based on an input image using a local enhancement network as a part of a first stage, wherein the local enhancement network includes a local image encoder that generates local enhancement data that indicates one or more image enhancement techniques to apply to a local region of the input image; and generating globally-enhanced image data based on the locally-enhanced image data using a global enhancement network as a part of a second stage, wherein the global enhancement network includes a plurality of global feature subnetworks, and wherein each of the global feature subnetworks is configured to draw attention to a different aspect of the locally-enhanced image data.

According to various embodiments, the method may further include any one of the following features or any technically-feasible combination of some or all of the features:
the local image encoder generates a degradation profile for each of a plurality of regions of the input image, and the degradation profile indicates the one or more image enhancement techniques to apply to the local region of the input image
each degradation profile specifies one or more degradation type-value items, each degradation type-value item specifies a degradation type for a degradation and a degradation value that indicates an associated value or flag representing an extent or presence of the degradation;
the plurality of global feature subnetworks include a global channel feature subnetwork that draws attention between channels;
the plurality of global feature subnetworks include a global pixel feature subnetwork that draws attention between pixels;
the plurality of global feature subnetworks include a global spatial feature subnetwork that draws attention between spatial regions;
the global enhancement network includes a global image encoder and a global image decoder downstream of and coupled to the global image encoder, wherein the global image encoder is configured to receive the locally-enhanced image data as input and the global image decoder is configured to generate global enhancement data that is used to generate the globally-enhanced image data;
the global image encoder and the global image decoder form a convolutional neural network;
the global image encoder and the global image decoder include skip connections; and/or
each of the plurality of global feature subnetworks includes an attention mechanism that draws attention across inputs;

According to another aspect of the disclosure, there is provided a method for enhancing an input image using a dual-stage image enhancement network. The method includes: generating locally-enhanced image data based on an input image using a local enhancement network as a part of a first stage, wherein the local enhancement network includes a local image encoder that generates local enhancement data that indicates one or more image enhancement techniques to apply to a local region of the input image; and generating globally-enhanced image data based on the locally-enhanced image data using a global enhancement network as a part of a second stage, wherein the global enhancement network includes a plurality of global feature subnetworks, and wherein at least one of the global feature subnetworks is configured to generate attention data that draws attention across channels, pixels, and/or spatial regions of the locally-enhanced image data.

According to various embodiments, the method may further include any one of the following features or any technically-feasible combination of some or all of the features:
each of the global feature subnetworks is configured to generate attention data, including a first global feature subnetwork configured to generate channel attention data for drawing attention across channels, a second global feature subnetwork configured to generate pixel attention data for drawing attention across pixels, and a third global feature subnetwork configured to generate spatial region attention data for drawing attention across spatial regions;
the method is performed by a vehicle, wherein the method is used for image;
enhancement of captured image data, and wherein the captured image data is image data captured from a camera of the vehicle; and/or
the globally-enhanced image data is used by the vehicle for display to a user of the vehicle.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating a dual-stage image enhancement network or system, according to one embodiment;

FIG. 2 is a block diagram illustrating a local image enhancement network that is used as a part of a first stage of the dual-stage image enhancement network of FIG. 1, according to one embodiment;

FIG. 3 is a block diagram illustrating a global image enhancement network that is used as a part of a second stage of the dual-stage image enhancement network of FIG. 1, according to one embodiment;

FIG. 4 is a block diagram illustrating convolution processing that may be performed prior to use of an attention mechanism or other input into a global feature subnetwork of the global image enhancement network of FIG. 3, according to one embodiment;

FIG. 5 is a block diagram illustrating an attention mechanism for channel attention that is used by a global channel feature subnetwork of the global image enhancement network of FIG. 3, according to one embodiment;

FIG. 6 is a block diagram illustrating an attention mechanism for pixel attention that is used by a global pixel feature subnetwork of the global image enhancement network of FIG. 3, according to one embodiment;

FIG. 7 is a block diagram illustrating an attention mechanism for spatial attention that is used by a global spatial feature subnetwork of the global image enhancement network of FIG. 3, according to one embodiment;

FIG. 8 is a block diagram illustrating a convolution block within an encoder-decoder segmentation network, such as those that may be used for the global feature subnetwork(s) of the global image enhancement network;

FIG. 9 is a flowchart illustrating a method for enhancing an input image using a dual-stage image enhancement network, according to one embodiment; and

FIG. 10 is a block diagram depicting an operating environment that includes an image enhancement system that is used to carry out one or more of the methods described herein, according to one embodiment.

### DETAILED DESCRIPTION

A system and method is provided for enhancing an input image using a dual-stage local and global image enhancement mechanism defined by a local image enhancement stage and a global image enhancement stage, particularly where the local image enhancement stage includes generating locally-enhanced image data that is then used as input by the global image enhancement stage for generating a locally-and-globally-enhanced image (or “dual-stage enhanced image”) by virtue of global image enhancements being introduced by the global image enhancement stage.

According to embodiments, the local image enhancement stage is performed by a local image enhancement network that generates a degradation profile for each local region of a plurality of local regions within the input image. The degradation profile includes one or more degradation values that indicate an extent or presence of a degradation within the local region. In embodiments, the degradation values are used to process the local region of the input image to generate locally-enhanced image data, which is image data representing the local region of the input image as locally-enhanced through processing according to the degradation values. In at least some embodiments, a plurality of different degradation values are determined, each of which may be for a different degradation type. A “degradation type-value item” is a degradation value for a degradation of a particular degradation type; for example, according to one embodiment, for a given local region, eight degradation type-value items are determined with each corresponding to a different one of the following degradation types: tone mapping, contrast adjustment, sharpening, gamma correction, white balance, identity, color correction, Contrast Limited Adaptive Histogram Equalization (CLAHE), brightness adjustment/low-light image enhancement (LLIE), and pixel degradation (patch degradation probability/intensity).

According to embodiments, the global image enhancement stage is performed by a global image enhancement network, which takes, as input, locally-enhanced image data that is then processed in order to generate globally-enhanced image data; at least in the present embodiment, this data is also dual-stage enhanced image data representing a dual-stage enhanced image that is enhanced at both a local level and global level. In embodiments, the global image enhancement network includes an attention mechanism coupled to a global image encoder, where the attention mechanism is used to draw attention to certain aspects within the data that is to be input into the global image encoder. More particularly, in an embodiment, the global image enhancement network includes a plurality of global image feature subnetworks, each of may include an encoder and decoder. In embodiments, each global image feature subnetwork includes an attention mechanism that is drawn to a certain feature or characteristic of the input image. For example, according to one embodiment, the global image enhancement network includes three global image feature subnetworks: a first global image feature subnetwork that has attention drawn to channel features, a second global image feature subnetwork that has attention drawn to pixel features, and a third global image feature subnetwork that has attention drawn to spatial features. Results from each of the global image feature subnetworks are combined to form a single enhanced output image.

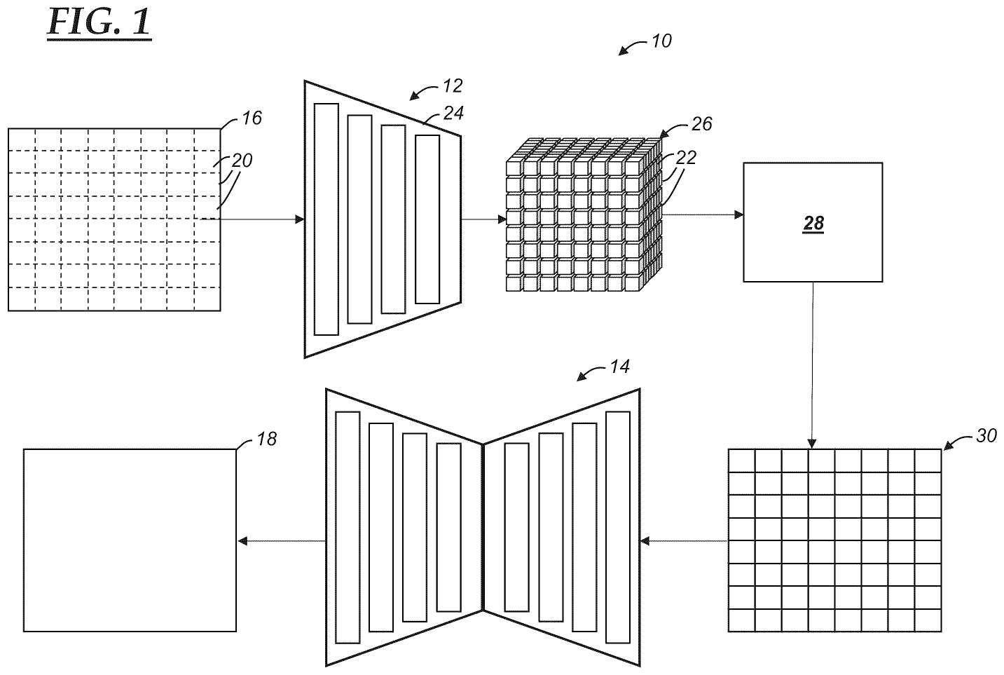

With reference to FIG. 1, there is shown an exemplary dual-stage image enhancement network or system 10 that includes a local image enhancement network 12 and a global image enhancement network 14, which are used to transform an input image 16 into an enhanced image 18, which is an enhanced version of the input image 16. In the depicted embodiment, the dual-stage image enhancement network or system 10 is configured to generate a locally-enhanced image data for each of a plurality of local regions 20, sixty four (64) local regions are shown in the input image 16 of the depicted embodiment. Of course, it will be appreciated that the number of local regions, as well as the shape, size, or other like attributes, may be adjusted for the particular implementation in which the system 10 is being used or is to be used.

For each of the local regions, a degradation profile 22 is generated for each of the plurality of local regions 20; in the depicted embodiment, each degradation profile 22 is comprised of eight (8) degradation type-value items, each of which corresponds to a different degradation type. In the depicted embodiment, a local image encoder 24 is used to generate a degradation profile for a local region corresponding to local region data that is input into the local image encoder 24. The local image encoder 24 is used to encode image data for a local region (“local image data”) into local degradation data 26, which is data that specifies the degradation profile for a local region. The local degradation data 26 for the sixty four (64) local regions 20 is shown together as a large three-dimensional cube, where each degradation profile (or local degradation data) includes eight blocks (small cubes), each of which represents a degradation type-value item. Thus, the local degradation data 26 includes 512 (64×8) degradation type-value items.

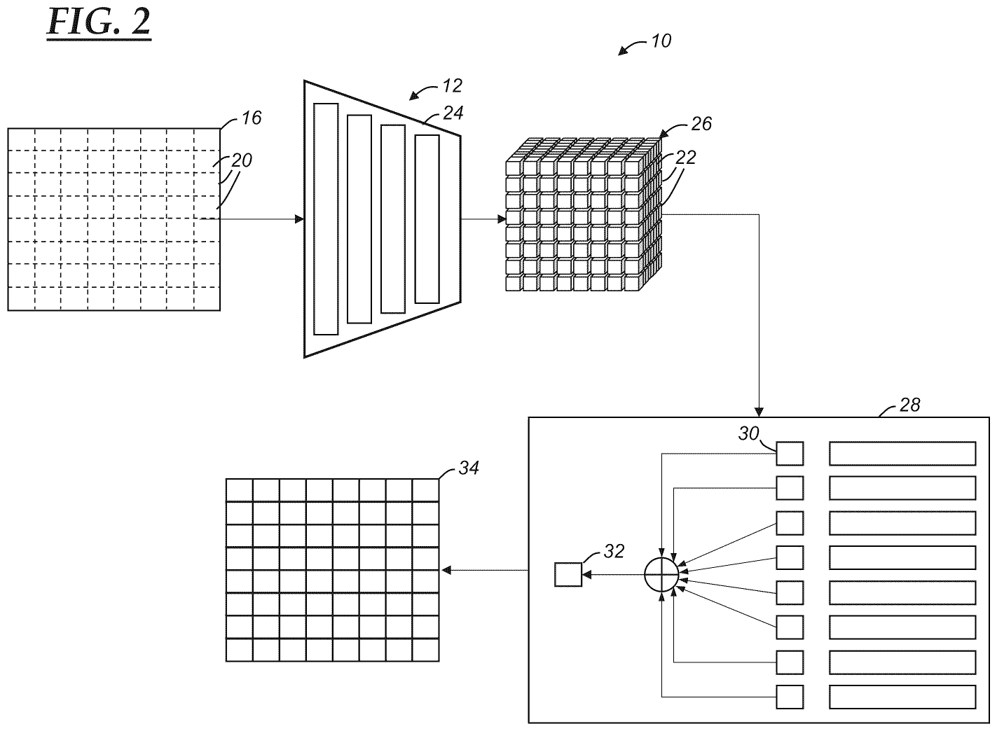

With reference to FIG. 2, there is shown the local image enhancement network 12, including the local image encoder 24, the local degradation data 26, and an image enhancement applicator 28 that applies image processing techniques to the local image data according to the degradation profile for the corresponding local region in order to generate processed local image data 30. The processed local image data 30 is merged or combined into a composite local image 32 for the local region, and the plurality of local images are combined in order to form a locally-enhanced image 34. The locally-enhanced image 34 is output by the local image enhancement network 12, and may be used by other networks or modules, such as the global image enhancement network 14.

In the present embodiment, the local image encoder 24 is a convolutional neural network encoder that includes a plurality of neural layers connecting an input layer of the local image encoder 24 at which local image data is input and an output layer of the local image encoder 24 at which the degradation profile is output. The local image encoder 24 performs convolution operations on input image data, and reduces the input space to a feature space at which the degradation profile may be acquired from.

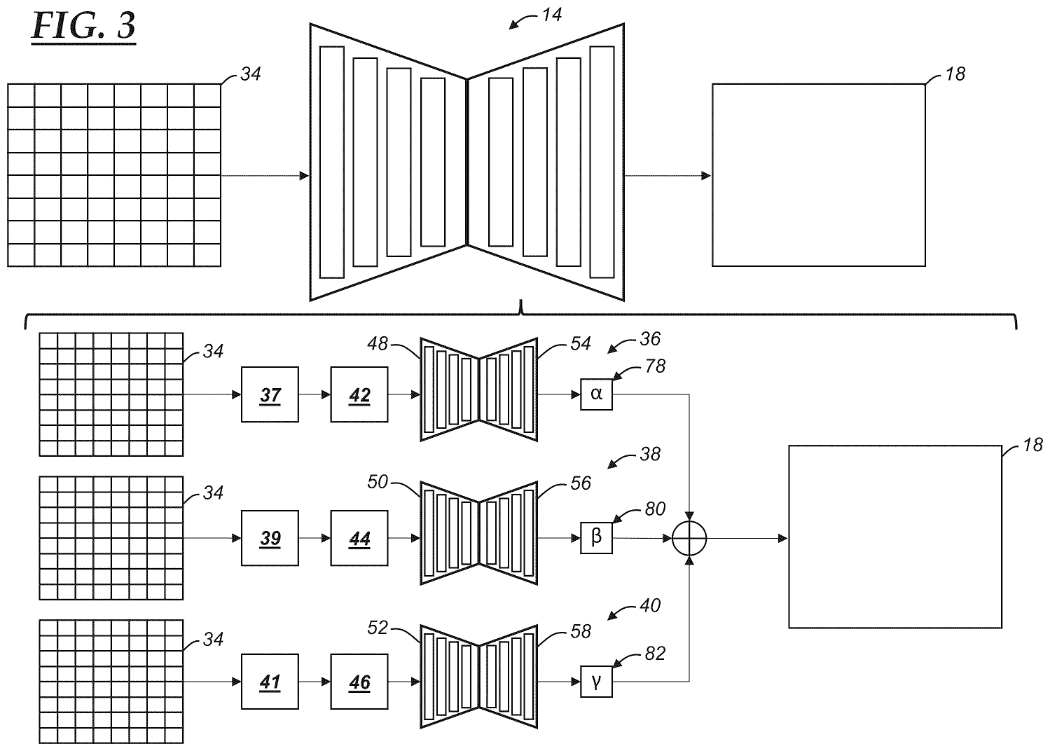

With reference to FIG. 3, there is shown the global image enhancement network 14, including a plurality of global image feature subnetworks, namely a global channel feature subnetwork 36, a global pixel feature subnetwork 38, and a global spatial feature subnetwork 40. The global image enhancement network 14 is depicted in FIG. 3 at the top as a bow-tic structure, highlighting the encoder-decoder processing nature of the global image enhancement network 14 generally; however, it will be appreciated that the particular makeup of the global image enhancement network 14 includes various subcomponents, which may be selected and/or configured in a variety of manners. In particular, for example, in the present depicted embodiment, the global image enhancement network 14 includes a plurality of feature subnetworks 36,38,40, which are described in more detail below.

Each of these feature subnetworks 36,38,40 is a feature subnetwork that takes a full (global) image and generates a corresponding output, with attention being drawn to a particular feature of the image, such as channel features in the case of the channel feature subnetwork 36, image features in the case of the pixel feature subnetwork 38, and spatial features in the case of the spatial feature subnetwork 40. Each of the feature subnetworks 36,38,40 includes an attention layer 42,44,46, a global image encoder 48,50,52, and a global image decoder 54,56,58. According to embodiments, the convolution operations performed below ay use a kernel size, padding, and a step size configured for the particular application. However, according to some embodiments, a kernel size of 3, a step size of 1, and a padding size of 1 may be used. And, in some embodiments, such as for depth wise convolution, a kernel size of 3, a padding size of 2, and step size of 2 may be used.

The global channel feature subnetwork 36 executes a processing flow that uses its attention layer 42 to draw attention across channels through use of channel feature data and a convolution output that is generated based on the image data input into the attention layer 42. As used herein, drawing attention across channels for image data means processing the image data to identify correlations amongst channel information within the image data. This generated attention data (here, the channel attention data or output 62 discussed below) as input into a convolutional neural network (or other feed-forward type neural network or like network), such as the global image encoder 48 and global image decoder 54. The attention layer 42 of the global channel feature subnetwork 36 is used to extract features along the channel dimension and to interlink and amplify these features. For example, the number of channels may be 32 (C=32), and a feature block of 32, W, H is used once for channel attention. The channel attention (which is carried out by the attention layer 42) amplifies meaningful features from these C dimensions based on maximum values per channel dimension. Hence, it determines which one or more channels out of all of the C channels contains information of interest.

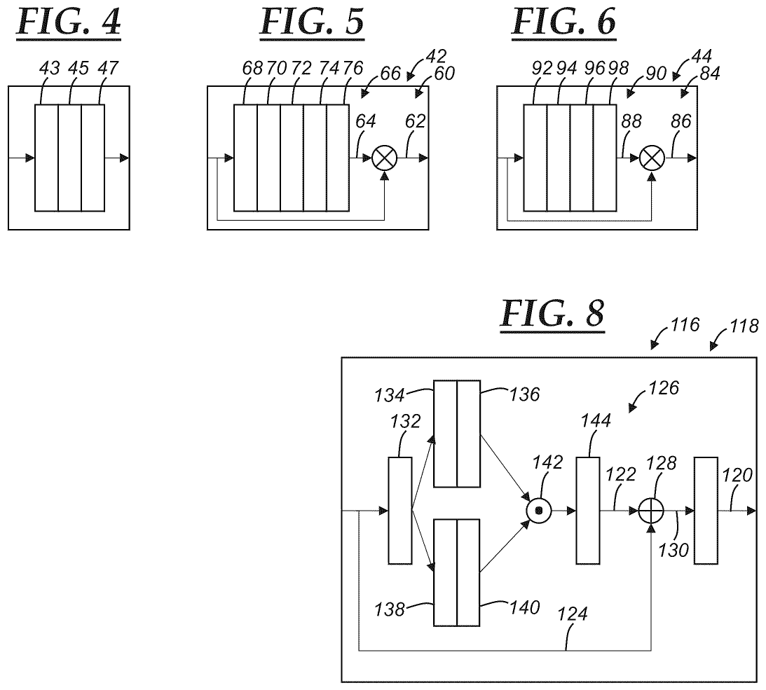

The channel feature data is extracted from the input image data, which may be the locally-enhanced image generated by the local image enhancement network 12. In embodiments, including the present embodiment, a convolution subprocess 37 is performed, and may include performing the operations shown in FIG. 4. In particular, for the global channel feature subnetwork 36, the subprocess 37 includes performing a first convolution operation 43, a PreLU activation operation 45, and a second convolution operation 47.

With continued reference to FIG. 3, and with particular reference now to FIG. 5, in at least in the present embodiment, the attention layer 42 includes processing blocks shown more particularly in FIG. 5 as a channel feature attention mechanism 60. The channel feature attention mechanism 60 is shown in FIG. 5 by which process flows in the direction of the arrows from left to right. In general, a channel attention output 62 is generated based on the input image data and a convolution output 64 is generated using a convolution process 66 that is also based on the input image data, which is shown as being passed into a first block of the convolution process 66. The convolution process 66 of the channel feature attention mechanism 60 includes: a global average pooling operation 68, a first convolution operation 70, a PreLU activation 72, a second convolution operation 74, and a sigmoid activation operation 76 that produces the convolution output 64. The convolution output 64 is then multiplied (tensor product) to the input data to generate the channel attention output 62.

The channel attention output 62 is then passed into the global image encoder 48 of the global channel feature subnetwork 36, as shown in FIG. 3. The global image encoder 48 generates feature encodings that are used as input into the global image decoder 54 of the global channel feature subnetwork 36. The global image decoder 54 generates a global channel feature output 78. Likewise, the global pixel feature subnetwork 38 and the global spatial feature subnetwork 40 each generate a global feature output, namely a global pixel feature output 80 and a global spatial feature output 82, respectively, as shown in FIG. 3.

The global pixel feature subnetwork 38 executes a processing flow that uses its attention layer 44 to draw attention across pixels through use of pixel feature data and a convolution output, which may be generated from the image data. As used herein, drawing attention across pixels means processing the image data to identify correlations amongst channel information within across a pixel. This generated attention data (here, the pixel attention data or output 86 discussed below) as input into a convolutional neural network (or other feed-forward type neural network or like network), such as the global image encoder 50 and global image decoder 56. The attention layer 44 of the global pixel feature subnetwork 38 is used to extract features along the channel dimension through looking or inspecting each pixel. For example, the number of channels may be 32 (C=32), and a feature block of 32, 1, 1 is used once for pixel attention. The pixel attention (which is carried out by the attention layer 44) amplifies meaningful features from these C dimensions amongst an individual pixel, and preserves the local statistics by only checking if this particular feature is of interest.

The pixel feature data is extracted from the input image data, which may be the locally-enhanced image generated by the local image enhancement network 12. In particular, at least in the present embodiment, the attention layer 44 includes processing blocks shown more particularly in FIG. 6 as a pixel feature attention mechanism 84. The pixel feature attention mechanism 84 is shown in FIG. 6 by which process flows in the direction of the arrows from left to right. In general, a pixel attention output 86 is generated based on the input image data and a convolution output 88 is generated using a convolution process 90 that is also based on the input image data, which is shown as being passed into a first block of the convolution process 90. The convolution process 90 of the pixel feature attention mechanism 84 includes: a first convolution operation 92, a PreLU activation 94, a second convolution operation 96, and a sigmoid activation operation 98 that produces the convolution output 88. The convolution output 88 is then multiplied (tensor product) to the input data to generate the pixel attention output 86.

The pixel attention output 86 is then passed into the global image encoder 50 of the global pixel feature subnetwork 38, as shown in FIG. 4. The global image encoder 50 generates feature encodings that are used as input into the global image decoder 56 of the global pixel feature subnetwork 38. The global image decoder 56 generates the global pixel feature output 80.

The global spatial feature subnetwork 40 executes a processing flow that starts with image data as input into its attention layer 46, which draws attention to across spatial regions of the image through use of spatial feature data being used along with a convolution output generated from the image data input into the attention layer 46. As used herein, drawing attention across spatial regions means processing the image data to identify correlations of neighboring pixels within various spatial regions (as defined by a kernel) across the image data. For example, in the present embodiment, the spatial attention is used to correlate information of neighboring pixels in order to determine information content if the central pixel in a convolutional kernel is destroyed. This generated attention data (here, the spatial attention data or output 102 discussed below) as input into a convolutional neural network (or other feed-forward type neural network or like network), such as the global image encoder 52 and global image decoder 58. The attention layer 46 of the global spatial feature subnetwork 40 is used to extract features along the channel dimension through looking or inspecting neighboring pixels as defined by the kernel, which may be, for example, sized as 3×3, 5×5, 31×31, depending on a variety of factors relating to the implementation and specific application in which it is used. For example, the number of channels may be 32 (C=32), and a feature block of 32, W. H is used once for spatial attention with a kernel that operates over various spatial regions within the image data. The spatial attention (which is carried out by the attention layer 46) amplifies meaningful features amongst neighboring pixels. In embodiments, because computational complexity may be high for a kernel with a size of 31×31, spatial attention is utilized after each down-sampling operation to ensure a large receptive field for the convolutional layer while keeping the computational footprint low.

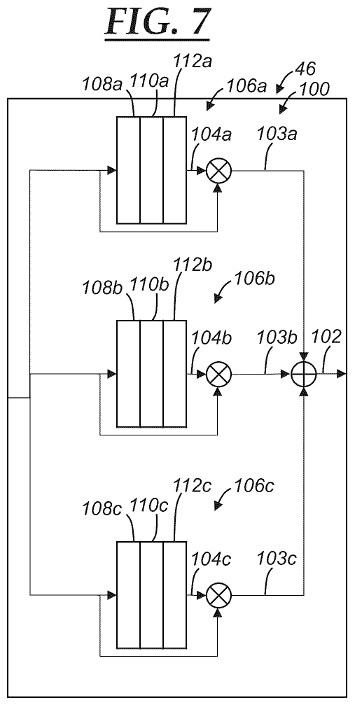

The spatial feature data is extracted from the input image data, which may be the locally-enhanced image generated by the local image enhancement network 12. In particular, at least in the present embodiment, the attention layer 46 includes processing blocks shown more particularly in FIG. 7 as a spatial feature attention mechanism 100. The spatial feature attention mechanism 100 is, in the present embodiment, in FIG. 7 by which process flows in the direction of the arrows from left to right. In general, a spatial attention output 102 is generated based on the input image data and a convolution output 104a,b,c is generated for each of three branching processing flows through use of a respective convolution process 106a,b,c that is also based on the input image data, which is shown as being passed into a first block of each of the convolution processes 106a,b,c. The convolution processes 106a,b,c are the same except a different kernel size is used for each one, such as a 3×3 convolution kernel for 106a, a 5×5 convolution kernel for 106b, and a 7×7 convolution kernel for 106c, for example. In the illustrated embodiment, each of the convolution processes 106a,b,c includes: a layer normalization operation 108a,b,c, a convolution operation 110a,b,c, and a sigmoid activation operation 112a,b,c that produces the convolution output 104a,b,c. The convolution operation 110a performs a 3×3 convolution with its 3×3 kernel, the convolution operation 110b performs a 5×5 convolution with its 5×5 kernel, and the convolution operation 110c performs a 7×7 convolution with its 7×7 kernel. The convolution output 104a,b,c is then multiplied (tensor product) to the input data to generate a spatial attention sub-output 103a,b,c, which are then added (direct sum) to generate the spatial attention output 102. In embodiments, a spatial feature attention mechanism, such as the spatial feature attention mechanism 100, may be used after each encoder and decoder layer in the global image encoder 52 and global image decoder 58.

The spatial attention output 102 is then passed into the global image encoder 52 of the global spatial feature subnetwork 40, as shown in FIG. 4. The global image encoder 52 generates feature encodings that are used as input into the global image decoder 58 of the global spatial feature subnetwork 40. The global image decoder 58 generates the global spatial feature output 82.

In embodiments, one or more of the global feature subnetworks 36,38,40 are configured with skip connections that are drawn across its respective global image encoder 48,50,52 and global image decoder 54,56,58; for example, an encoder-decoder segmentation network, such as U-NET, may be used.

With reference to FIG. 8, there is shown a convolution block 116 within an encoder-decoder segmentation network 118, such as those used for the global channel feature subnetwork 36, the global pixel feature subnetwork 38, and the global spatial feature subnetwork 40. In particular, at least according to the present embodiment, the encoder-decoder segmentation network 118 is used for implementing the convolutional encoder-decoder segmentation networks; in the present embodiment, there are three convolutional encoder-decoder segmentation networks, each corresponding to the global image encoder 48,50,52 and the global image decoder 54,56,58, respectively. As discussed above, a U-NET or other convolutional encoder-decoder segmentation network having skip connections may be used.

The convolution block 116 shown in the embodiment of FIG. 8 includes generating a convolution block output 120, based on a convolution process output 122 and a convolution block input 124. The convolution block 116 begins with flow starting on the left, whereat the convolution block input 124 is received and input both into a convolution process 126 and into an adder (direct sum) 128 used to generate an initial convolution output 130. The convolution process 126 is used to generate the convolution process output 122, and begins with first performing a batch normalization operation 132, and then using the output of the batch normalization for performing a first pointwise convolution operation 134 and then a sigmoid activation operation 136; in a similar manner, a second pointwise convolution operation 138 is performed on the output of the batch normalization operation 132 and then a depth wise convolution operation 140 is performed. The outputs of the sigmoid activation operation 136 and the depth wise convolution operation 140 are then pointwise or element-wise multiplied. This product is then input into a third pointwise convolution operation 144 that then generates the convolution process output 122. The convolution process output 122 and the convolution block input 124 are then direct summed using the adder 128 to generate the initial convolution output 130. A depth wise convolution operation is then performed on the initial convolution output 130 to generate the convolution block output 120. This convolution block output 120 may be used as a convolution block input into a next convolution block or layer.

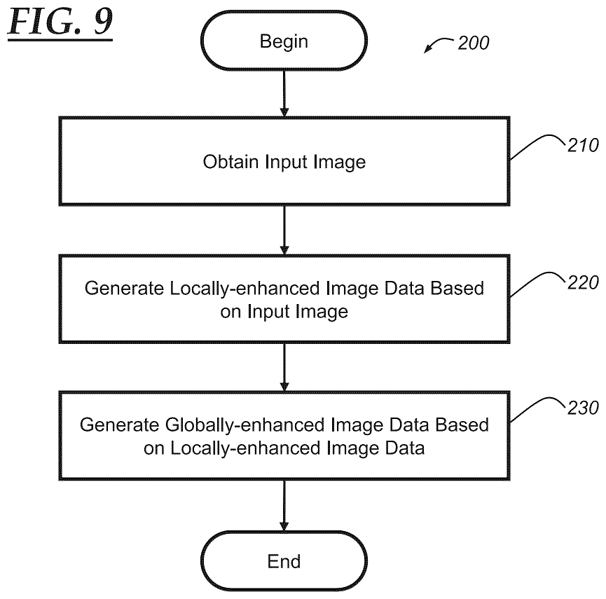

With reference to FIG. 9, there is shown an embodiment of a method 200 of generating an enhanced image. The method 200 is discussed as being performed by the dual-stage image enhancement system 10 discussed above. The method 200 begins with step 210, wherein an input image is obtained. In embodiments, the input image is an image captured by an image sensor, such as a digital camera, and, in at least some embodiments, the input image is a photorealistic image captured by a camera, such as an image captured by a back-up or reverse camera on a car or vehicle. The input image is represented by image data that is obtained and that may be organized into a matrix, such as a two-dimensional matrix of pixel data. The method 200 continues to step 220.

In step 220, locally-enhanced image data is generated based on the input image. In embodiments, the local enhancement network 12 is used to generate the locally-enhanced image data. In embodiments, this step includes splitting the input image into a plurality of local regions; for example, as shown in FIG. 2, the input image 16 is divided into a plurality of local regions 20, which may also be referred to as local blocks. In the present embodiment, the input image 16 is split into sixty four (64) evenly-sized rectangles, each corresponding to a two-dimensional matrix representation of a sub-portion of the input image 16. Then, the input image data for each local region of the local regions 20, which is referred to as local input image data or local image data, is input into the local image encoder 24 to generate the degradation profile 22 for the local region. The degradation profile 22 for the local region is then used to enhance the local input image data thereby generating enhanced local image data; thus, in the present illustrated embodiment of FIG. 2, sixty four (64) sets of enhanced local image data are generated using the local image encoder 24—one set of enhanced local image data for each local region. The enhanced local image data is then merged back together (a reverse of the split initially performed) so that the local regions are located in the same relative location as they were when in the input image. Thus, the locally-enhanced image data represents the input image as it has been enhanced at each local region. The method 200 continues to step 230.

Since the degradation profiles 22 for the various local regions 20 varies and, accordingly, image enhancements (which are made based on the degradation profile) vary between local regions 20. This causes the local regions within the locally-enhanced image to be visually discernible since, at least in many images under typical scenarios, image enhancements cause inconsistencies, such as through adjustments to exposures or luminance, white balance, hue, contrast, etc. Such inconsistencies between local regions are represented in FIG. 2 by the solid line gridding shown in the locally-enhanced image 24. Accordingly, at least in embodiments, a dual-stage image enhancement system, such as the system 10 described above, is used to perform two stages, the first being a local enhancement stage wherein locally-enhanced image data is generated and the second being a global enhancement stage wherein globally-enhanced image data is generated. In the global enhancement stage, the image data is considered as a whole (not in groups or sets of local regions) and this results in removing inconsistencies between local regions that may arise from the local enhancement stage, as discussed above. In the present embodiment, this step used to generate the locally-enhanced image data is the first stage and the following step 230, which is used to generate the globally-enhanced image data, is the second stage.

In step 230, globally-enhanced image data is generated based on the locally-enhanced image data. In embodiments, the global enhancement network 14 is used to generate the globally-enhanced image data based on using the locally-enhanced image data as input. In embodiments, this step includes a multi-headed approach in which three subnetworks, such as the three global feature subnetworks 36,38,40, are used to each generate a respective subnetwork output (feature outputs 78,80,82) that are then merged together to generate the globally-enhanced image data, which represents a globally-enhanced image. In embodiments, the feature subnetworks are used to draw attention to certain aspects of image data and, in the illustrated embodiment, draw attention across channels, pixels, and spatial regions using the global channel feature subnetwork 36, the global pixel feature subnetwork 36, and the global spatial feature subnetwork 40, respectively. The method 200 then ends.

According to embodiments, the globally-enhanced image data may be further processed and/or displayed on a display, such as a light emitting diode (LED) display or other electronic display. The globally-enhanced image data may also be stored in memory.

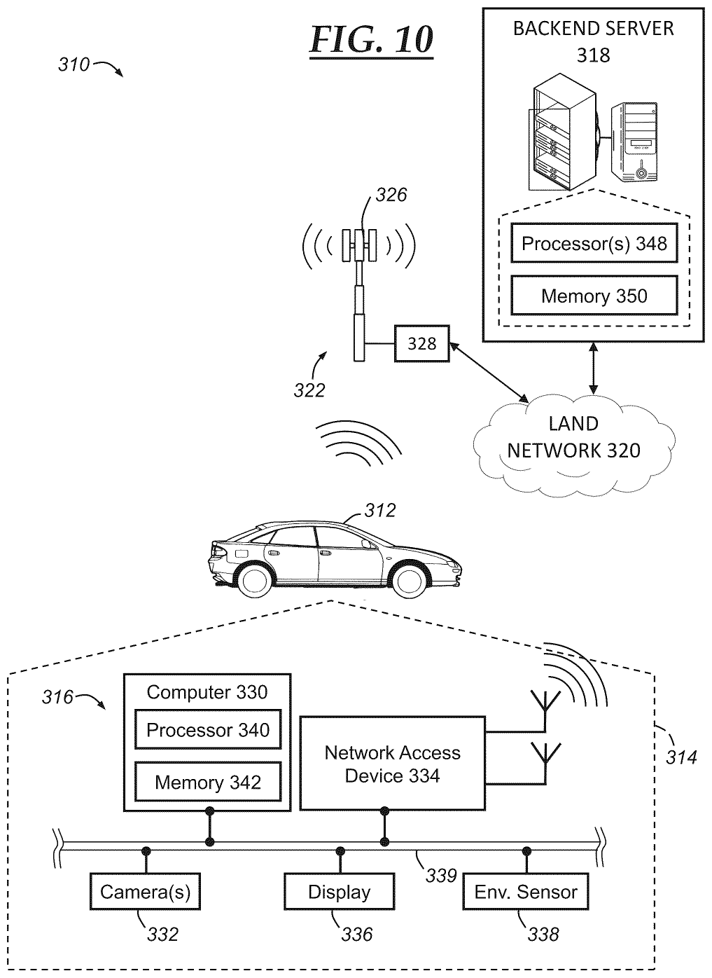

With reference now to FIG. 10, there is shown an operating environment that comprises a communications system 310, a vehicle 312 having vehicle electronics 314 including an image enhancement system 316, one or more backend servers 318, a land network 320, and a wireless carrier system 322. According to at least some embodiments, the image enhancement system 316 is configured to carry out one or more of the methods described herein, such as methods 200 (FIG. 9). It will be appreciated that although the image enhancement system 316 is discussed in the context of a vehicular application, the image enhancement system 316 may be used as a part of a variety of other applications or contexts, such as where the image enhancement system 316 is incorporated into a handheld mobile device (e.g., smartphone), a personal computer (e.g., laptop, desktop computer), or cloud processing system. In one embodiment, the image enhancement system 316 is incorporated into another computer or computer system, such as the backend server(s) 318.

The land network 320 and the wireless carrier system 322 provide an exemplary long-range communication or data connection between the vehicle 312 and the backend server(s) 318, for example. Either or both of the land network 20 and the wireless carrier system 22 may be used by the vehicle 312, the backend server(s) 318, or other component for long-range communications. The land network 320 may be any suitable long-range electronic data network, including a conventional land-based telecommunications network that is connected to one or more landline telephones and connects the wireless carrier system 322 to the backend server(s) 318, for example. In some embodiments, the land network 320 may include a public switched telephone network (PSTN) such as that used to provide hardwired telephony, packet-switched data communications, and the Internet infrastructure. One or more segments of the land network 320 may be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 322 may be any suitable wireless long-range data transmission system, such as a cellular telephone system. The wireless carrier system 322 is shown as including a single cellular tower 326; however, the wireless carrier system 322 may include additional cellular towers as well as one or more of the following components, which may depend on the cellular technology being used: base transceiver stations, mobile switching centers, base station controllers, evolved nodes (e.g., eNodeBs), mobility management entities (MMEs), serving and PGN gateways, etc., as well as any other networking components used to connect the wireless carrier system 322 with the land network 320 or to connect the wireless carrier system 322 with user equipment (UEs, e.g., which may include telematics equipment in the vehicle 312), all of which is indicated generally at 328. The wireless carrier system 322 may implement any suitable communications technology, including for example GSM/GPRS technology, CDMA or CDMA2000 technology, LTE technology, 5G, etc. In at least one embodiment, the wireless carrier system 322 implements 5G cellular communication technology and includes suitable hardware and configuration. In some such embodiments, the wireless carrier system 322 provides a 5G network usable by the vehicle 312 for communicating with the backend server(s) 318 or other computer/device remotely located from the vehicle 312. In general, the wireless carrier system 322, its components, the arrangement of its components, the interaction between the components, etc. is generally known in the art.

The vehicle 312 is depicted in the illustrated embodiment as a passenger car, but it should be appreciated that any other vehicle including motorcycles, trucks, sports utility vehicles (SUVs), recreational vehicles (RVs), bicycles, other vehicles or mobility devices that can be used on a roadway or sidewalk, etc., can also be used. As depicted in the illustrated embodiment, the vehicle 312 includes the vehicle electronics 314, which include an onboard vehicle computer 330, one or more cameras 332, a network access device 334, an electronic display (or “display”) 336, one or more environmental sensors 338, and a vehicle communications bus 339. FIG. 10 provides an example of certain components of the vehicle electronics 314, however, it will be appreciated that, according to various embodiments, the vehicle electronics 314 may include one or more other components in addition to or in lieu of those components depicted in FIG. 10.

The one or more cameras 332 are each an image sensor used to obtain an input image having image data of the vehicle's environment, and the image data, which represents an image captured by the camera(s) 332, may be represented as an array of pixels that specify color information. The camera(s) 332 may each be any suitable digital camera or image sensor, such as a complementary metal-oxide-semiconductor (CMOS) camera/sensor. The camera(s) 332 are each connected to the vehicle communications bus 339 and may provide image data to the onboard vehicle computer 330. In some embodiments, image data from one or more of the camera(s) 332 is provided to the backend server(s) 318. The camera(s) 332 may be mounted so as to view various portions within or surrounding the vehicle. It should be appreciated that other types of image sensors may be used besides cameras that capture visible (RGB) light, such as thermal or infrared image sensors, and/or various others.

The network access device 334 is used by the vehicle 312 to access network(s) that are external to the vehicle 312, such as a home Wi-Fi™ network of a vehicle operator or one or more networks of the backend server(s) 318. The network access device 334 includes a short-range wireless communications (SRWC) circuit (not shown) and a cellular chipset (not shown) that are used for wireless communications. The SRWC circuit includes an antenna and is configured to carry out one or more SRWC technologies, such as any one or more of the IEEE 802.11 protocols (e.g., IEEE 802.11p, Wi-Fi™), WiMAX™, ZigBee™, Z-Wave™, Wi-Fi Direct™, Bluetooth™ (e.g., Bluetooth™ Low Energy (BLE)), and/or near field communication (NFC). The cellular chipset includes an antenna and is used for carrying out cellular communications or long-range radio communications with the wireless carrier system 322, and the cellular chipset may be part of a vehicle telematics unit. And, in one embodiment, the cellular chipset includes suitable 5G hardware and 5G configuration so that 5G communications may be carried out between the vehicle 312 and the wireless carrier system 322, such as for purposes of carrying out communications between the vehicle 312 and one or more remote devices/computers, such as those implementing the backend server(s) 318.

The one or more environment sensors (or environment sensor(s)) 338 are used to capture environment sensor data indicating a state of the environment in which the camera(s) 332 (and the vehicle 312) is located. At least in some embodiments, the environment sensor data is used as a part of the method described herein in order to generate sensor feature fusion data. The environment sensor(s) 338 may each be any of a variety of environment sensors, which is any sensor that captures environment sensor data; for example, examples of environment sensors include a camera, another image sensor, a thermometer, a precipitation sensor, and a light sensor; however, a variety of other types of sensors may be used. The environment sensor data is used to determine environment feature information, which may be combined with extracted features from image data of an input image to generate the sensor feature fusion data usable for determining a degradation profile specifying enhancements to be applied to the input image to generate an enhanced image, as discussed below with regard to the method 200 (FIG. 9).

The onboard vehicle computer 330 is an onboard computer in that it is carried by the vehicle 312 and is considered a vehicle computer since it is a part of the vehicle electronics 314. The onboard vehicle computer 330 includes at least one processor 340 and non-transitory, computer-readable memory 342 that is accessible by the at least one processor 340. The onboard vehicle computer 330 may be used for various processing that is carried out at the vehicle 312 and, in at least one embodiment, forms at least a part of the image enhancement system 316 and is used to carry out one or more steps of one or more of the methods described herein, such as the method 200 (FIG. 9). The onboard vehicle computer 330 is connected to the vehicle communications bus 339 and may send messages to, and receive messages from, other vehicle components using this bus 339. The onboard vehicle computer 330 may be communicatively coupled to the network access device 334 so that data may be communicated between the onboard vehicle computer 330 and a remote network, such as the backend server(s) 318.

The image enhancement system 316 is used to carry out at least part of the one or more steps discussed herein. As shown in the illustrated embodiment, the image enhancement system 316 is implemented by one or more processors and memory of the vehicle 312, which may be or include the at least one processor 340 and memory 342 of the onboard vehicle computer 330. In some embodiments, the image enhancement system 316 may additionally include the camera(s) 332 and/or the environment sensor(s) 338. In one embodiment, at least one of the one or more processors carried by the vehicle 312 that forms a part of the image enhancement system 316 is a graphics processing unit (GPU). The memory 342 stores computer instructions that, when executed by the at least one processor 340, cause one or more of the methods (or at least one or more steps thereof), such as the method 200 (FIG. 9) discussed above, to be carried out. In embodiments, one or more other components of the vehicle 312 and/or the communications system 310 may be a part of the image enhancement system 316, such as the camera(s) 332 (or image sensor(s)) and/or the environment sensor(s) 338.

The one or more backend servers (or backend server(s)) 318 may be used to provide a backend for the vehicle 312, image enhancement system 316, and/or other components of the system 310. The backend server(s) 318 are shown as including one or more processors 348 and non-transitory, computer-readable memory 350. In one embodiment, the image enhancement system 316 is incorporated into the backend server(s) 318. For example, in at least one embodiment, the backend server(s) 318 are configured to carry out one or more steps of the methods described herein, such as the method 200 (FIG. 9). In another embodiment, the backend server(s) 318 is used to store information concerning and/or pertaining to the vehicle 312 or image enhancement system 316, such as predetermined degradation profile information, as described below. The predetermined degradation profile information is information that associates a particular degradation (and/or features associated with the particular degradation) with an image enhancement technique. This information may be periodically updated by the backed server(s) 318 transmitting updated degradation profile information to the vehicle 312. The backend server(s) 318 may be implemented or hosted by one or more computers, each of which includes a processor and a non-transitory, computer-readable memory that is accessible by the processor.

In one embodiment, the backend server(s) 318 provide an application programming interface (API) that is configured to receive an input image from a remote computer system, generate an enhanced image using the method described herein, and then provide the enhanced image to the remote computer system, such that the backend server(s) 318 provide software as a service (SaaS) providing image enhancement according to the method described herein.

Any one or more of the processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It should be appreciated that any one or more of the computers discussed herein may include other memory, such as volatile RAM that is used by the processor, and/or multiple processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the word “enhancement”, “enhanced”, and its other forms are not to be construed as limiting the invention to any particular type or manner of image enhancement, but are generally used for facilitating understanding of the above-described technology, and particularly for conveying that such technology is used to address degradations of an image. However, it will be appreciated that a variety of image enhancement techniques may be used, and each image enhancement technique is a technique for addressing a specific degradation or class of degradations of an image, such as those examples provided herein.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method for enhancing an input image using a dual-stage image enhancement network, comprising the steps of:
generating locally-enhanced image data based on an input image using a local enhancement network as a part of a first stage, wherein the local enhancement network includes a local image encoder that generates local enhancement data that indicates one or more image enhancement techniques to apply to a local region of the input image; and
generating globally-enhanced image data based on the locally-enhanced image data using a global enhancement network as a part of a second stage, wherein the global enhancement network includes a plurality of global feature subnetworks, and wherein each of the global feature subnetworks is configured to draw attention to a different aspect of the locally-enhanced image data.

2. The method of claim 1, wherein the local image encoder generates a degradation profile for each of a plurality of regions of the input image, wherein the degradation profile indicates the one or more image enhancement techniques to apply to the local region of the input image.

3. The method of claim 2, wherein each degradation profile specifies one or more degradation type-value items, wherein each degradation type-value item specifies a degradation type for a degradation and a degradation value that indicates an associated value or flag representing an extent or presence of the degradation.

4. The method of claim 1, wherein the plurality of global feature subnetworks include a global channel feature subnetwork that draws attention between channels.

5. The method of claim 1, wherein the plurality of global feature subnetworks include a global pixel feature subnetwork that draws attention between pixels.

6. The method of claim 1, wherein the plurality of global feature subnetworks include a global spatial feature subnetwork that draws attention between spatial regions.

7. The method of claim 1, wherein the global enhancement network includes a global image encoder and a global image decoder downstream of and coupled to the global image encoder, wherein the global image encoder is configured to receive the locally-enhanced image data as input and the global image decoder is configured to generate global enhancement data that is used to generate the globally-enhanced image data.

8. The method of claim 1, wherein the global image encoder and the global image decoder form a convolutional neural network.

9. The method of claim 8, wherein the global image encoder and the global image decoder include skip connections.

10. The method of claim 1, wherein each of the plurality of global feature subnetworks includes an attention mechanism that draws attention across inputs.

11. A method for enhancing an input image using a dual-stage image enhancement network, comprising the steps of:
generating locally-enhanced image data based on an input image using a local enhancement network as a part of a first stage, wherein the local enhancement network includes a local image encoder that generates local enhancement data that indicates one or more image enhancement techniques to apply to a local region of the input image; and
generating globally-enhanced image data based on the locally-enhanced image data using a global enhancement network as a part of a second stage, wherein the global enhancement network includes a plurality of global feature subnetworks, and wherein at least one of the global feature subnetworks is configured to generate attention data that draws attention across channels, pixels, and/or spatial regions of the locally-enhanced image data.

12. The method of claim 11, wherein each of the global feature subnetworks is configured to generate attention data, including a first global feature subnetwork configured to generate channel attention data for drawing attention across channels, a second global feature subnetwork configured to generate pixel attention data for drawing attention across pixels, and a third global feature subnetwork configured to generate spatial region attention data for drawing attention across spatial regions.

13. The method of claim 12, wherein the method is performed by a vehicle, wherein the method is used for image enhancement of captured image data, and wherein the captured image data is image data captured from a camera of the vehicle.

14. The method of claim 13, wherein the globally-enhanced image data is used by the vehicle for display to a user of the vehicle.
